(19) United States
(12) Patent Application Publication
(10) Pub. No.: US 2020/0350646 A1
(43) Pub. Date: Nov. 5, 2020

(54) BATTERY SYSTEM, IN PARTICULAR FOR DRIVING A VEHICLE

(71) Applicant: Mahle International GmbH, Stuttgart (DE)

(72) Inventor: Johannes Weinmann, Stuttgart (DE)

(21) Appl. No.: 16/865,292

(22) Filed: May 1, 2020

(30) Foreign Application Priority Data
May 2, 2019 (DE) 10 2019 206 290.3
Sep. 2, 2019 (DE) 10 2019 213 191.3

(51) Int. Cl. H01M 10/6557; H01M 10/613; H01M 10/625; H01M 10/6568; H01M 2/10; F01P 7/14

(52) U.S. Cl. CPC H01M 10/6557; H01M 10/613; H01M 10/625; H01M 2220/20; H01M 2/1077; F01P 7/14; H01M 10/6568

(57) ABSTRACT

A battery system, in particular for driving a vehicle, includes a battery housing, accumulator cells, and a coolant pump. The battery housing includes a coolant inlet and a coolant outlet, wherein the coolant inlet is fluidically connected to the coolant pump. A valve which controls a volumetric coolant flow entering the battery housing is arranged between the coolant pump and the coolant inlet. An excessive coolant pressure within the battery housing can be counteracted in this way.

### CROSS REFERENCE TO RELATED APPLICATIONS

This application claims priority to German patent applications DE 10 2019 206 290.3, filed May 2, 2019 and DE 10 2019 213 191.3, filed Sep. 2, 2019, the entire content of these applications is incorporated herein by reference.

### TECHNICAL FIELD

The present disclosure relates to a battery system, in particular for driving a vehicle, as well as to a battery housing for such a battery system.

### BACKGROUND

Conventional battery systems which possess a battery housing having accumulator cells arranged therein are known. In order for overheating of said accumulator cells to be avoided when charging or discharging, said accumulator cells are cooled with a liquid coolant. The coolant herein directly flows around the accumulator cells arranged in the battery housing. A coolant pump which conveys the coolant through the battery housing is provided for the flow of the coolant. To this end, the coolant pump as well as the battery housing can be arranged in a cooling circuit in which the coolant circulates.

It proves disadvantageous in such conventional battery systems that an undesirable increase in the pressure of the coolant can arise in the battery housing when the cooling liquid backs up after entering the battery housing. A backup of this type can be created by clogging of a sub-region of the battery housing, in the discharge lines of the latter, or else in components which are arranged downstream in the battery housing. The root cause for an undesirable increase in the pressure of the coolant can in particular be clogging in a filter installation which is arranged downstream of the battery housing and through which the coolant is guided in order for dirt particles to be separated.

### SUMMARY

It is therefore an object of the present disclosure to provide a battery system which prevents or at least reduces an undesirable increase in the pressure in the battery housing.

This object is achieved by a battery system and a battery housing for a battery system as described herein.

Accordingly, it is a fundamental concept of the disclosure to provide a valve by means of which the volumetric flow of coolant entering the battery housing can be controlled between a coolant inlet provided on the battery housing and a coolant pump arranged upstream of the coolant inlet. When a predetermined threshold value of the coolant pressure in the battery housing is exceeded it can thus be prevented by suitable actuation of the valve that further coolant is conveyed into the battery housing and the components are thus damaged or deformed or that the tightness of the battery housing is compromised.

The battery system according to an aspect of the disclosure is in particular provided for driving a vehicle. To this end, the battery system according to an aspect of the disclosure has a battery housing in which accumulator cells are arranged. In order for the accumulator cells to be protected against overheating and/or undercooling, a temperature-controlling fluid which hereunder for simplification is referred to as coolant is provided. Said coolant is a dielectric liquid, in particular an oil, which can dissipate the heat created in the accumulator cells on the one hand, and in the event of an excessively cold environment can also supply heat to the accumulator cells on the other hand. The accumulator cells can thus be kept in a temperature range which is optimized in terms of the operation or the service life, respectively. A heat exchanger as is known in the prior art is provided in order for the coolant to be conditioned. A coolant pump which is likewise known from the prior art is provided in order for the coolant to be conveyed through the battery system. In order for the accumulator cells to be surrounded directly with the flow of the coolant, the battery housing possesses a coolant inlet which is embodied with an arbitrary, in particular round or oval, cross section. Alternatively, the coolant inlet may also possess a plurality of openings which may in particular be arranged at various locations in the battery housing.

The coolant inlet is typically integrated in a lateral wall of the battery housing, wherein the coolant inlet can alternatively also be arranged in a base region or cover region of the battery housing.

The battery housing furthermore possesses a coolant outlet which is typically arranged at a location in the battery housing which is positioned so as to be opposite the coolant inlet. In a manner analogous to the coolant inlet, the coolant outlet can likewise be integrated in the lateral walls as well as the cover regions or base regions, respectively.

The coolant inlet is fluidically connected to the coolant pump such that the coolant propelled by the coolant pump is conveyed through the coolant inlet into the battery housing. The battery housing as well as the coolant pump can be arranged in a coolant circuit in which the coolant circulates.

To avoid that an excessive fluid pressure is created by the coolant in the battery housing, said excessive fluid pressure potentially being caused, for example, by virtue of a clogged filter installation for filtering the coolant or by virtue of a malfunction of a conveying installation for propelling the coolant, a valve according to an aspect of the disclosure which controls volumetric flow of coolant entering the battery housing is arranged between the coolant inlet and the coolant pump. In the event of a marginal fluid pressure it is thus prevented that further coolant is conveyed into the battery housing and damages/deforms the components or compromises the battery housing tightness. The coolant pump herein is typically operated at a constant output since an output-regulated pump is more complex in terms of actuation and thus more expensive in terms of procurement.

Said threshold value for the fluid pressure of the coolant is typically 1.5 bar. It is to be noted here that all present pressure indications are to be interpreted as a pressure differential in relation to the normal pressure of 1 bar. The threshold value of 1.5 bar mentioned for the fluid pressure thus corresponds to an absolute fluid pressure of 2.5 bar.

Battery systems are usually operated at a coolant pressure of less than 2 bar; the prevailing pressure in the battery system is typically less than 1.5 bar. Reduced requirements pertaining to the basic design of the system, in particular the pressure resistance or tightness, respectively, are thus easier to implement.

In exemplary embodiments the valve can be arranged directly on the battery housing, in particular be connected to the latter. Alternatively however, the valve can also be integrated in the battery housing.

The valve is typically pressure-controlled by the coolant pressure, wherein the resetting of the valve can likewise be carried out in a pressure-controlled manner. Alternatively, however, the valve can also be spring-loaded or be electrically actuated. Exemplary embodiments having a pneumatic control unit are furthermore possible.

According to an exemplary embodiment of the disclosure, the valve is designed as a pressure-regulator valve or as a directional valve, wherein either the valve per se reduces the throughflow or releases an alternative flow path which is conceived in such a manner that only a reduced quantity of the coolant arrives in the battery housing. The valve can in particular release a bypass line on account of which a partial volumetric flow is directed past the battery housing.

In an exemplary embodiment of the disclosure, the valve is connected to two coolant ducts which in fluidic terms are arranged in parallel, wherein the first coolant duct is designed so as to be optimized for flow and has a low flow resistance to the coolant, and the second coolant duct is embodied in such a manner that said second coolant duct possesses a higher flow resistance than the first coolant duct. At a constant conveying output of the coolant pump in this exemplary embodiment, a reduced fluid pressure thus reaches the coolant inlet when the coolant has been directed through the second coolant duct.

According to an exemplary embodiment, the first and the second coolant duct fluidically communicate with the valve in such a manner that it can be set with the valve what proportion of the coolant that has entered the valve is directed into the first coolant duct and which proportion is directed into the second coolant duct.

According to an exemplary embodiment, a (first) position, in which the entire coolant that has entered the valve is directed into the first coolant duct and no coolant is directed into the second coolant duct, can be set in the valve. Alternatively or additionally, a second position, in which the entire coolant that has entered the valve is directed into the second coolant duct and no coolant is directed into the first coolant duct, can be set in the valve. The valve can typically be adjustable to at least a (third) position in which the coolant that has entered the valve is in part directed into the first coolant duct and in part directed into the second coolant duct. This permits the pressure generated by the coolant in the battery housing to be lowered also in a nominal operation of the battery system and in this way the battery housing to be exposed to a reduced continuous stress, on account of which the service life of the battery housing is increased.

A plurality of third positions can particularly typically be provided, said third positions differing from one another in terms of a splitting ratio by which it is established which proportion of the coolant flowing through the valve is directed into the first coolant duct and which, typically complementary, proportion of the coolant flowing through the valve is directed into the second coolant duct.

According to an exemplary embodiment of the disclosure, the second coolant duct has an interference geometry which possesses in particular at least one turbulence insert or/and at least one cover or/and at least one throttle or/and at least one cross-sectional reduction. The desired higher flow resistance of the second coolant duct can be implemented in a technically simple and thus cost-effective manner with the aforementioned measures individually or in combination.

In a further an exemplary embodiment of the battery system according to an aspect of the disclosure, the second coolant duct possesses a larger duct length than the first coolant duct, an increase in the flow resistance of the second coolant duct in comparison to the first coolant duct being created already by virtue of the larger duct length.

It is particularly advantageous for the second coolant duct to be configured so as to be meander-shaped and to be in particular arranged on a housing wall of the battery housing. A disposal of the lengthened flow duct that is optimized in terms of installation space is thus possible. The coolant duct herein can be configured as an insert part, in particular as a flexible hose, or as an extruded bent tube, or/and be installed on a housing wall of the battery housing and typically be fixed to the battery housing by way of brackets or/and snap-fit connections.

According to an exemplary embodiment of the disclosure, the second coolant duct is integrated in the housing wall of the battery housing. To this end, receptacles can be configured, for example as depressions, in the housing wall in which the second coolant duct is inserted, press-fitted, or over-moulded. Alternatively, however, a complete integration of the coolant duct in the housing wall is also possible. The housing wall of the battery housing hereby at least partially, typically completely, forms the duct wall of the coolant duct. This is implementable in a particularly simple manner in battery housings from plastics material since the coolant duct is made conjointly with the battery housing. The battery housing is typically produced from a thermoplastic material which can be embodied as an injection-moulded plastics material part. Alternatively, however, the battery housing can also be made from a more resilient thermosetting plastics material.

It is advantageous for the battery housing to be embodied in two parts, having a first and a second housing part, wherein the two housing parts are connected to one another in a sealing manner. The accumulator cells having the electrical contact thereof can thus be simply inserted into the battery housing and fixed therein.

Further important features and advantages of the disclosure are derived from the dependent claims, from the drawings, and from the associated description of the figures.

It is understood that the features mentioned above and yet to be explained hereunder can be used not only in the respective stated combination but also in other combinations or individually without departing from the scope of the present disclosure.

### BRIEF DESCRIPTION OF THE DRAWINGS

The disclosure will now be described with reference to the drawings wherein:

FIG. 1 shows a schematic and exemplary illustration of a battery system according to an exemplary embodiment of the disclosure;

FIG. 2 shows an enlarged partial illustration of the battery system shown in FIG. 1 in the region of the valve according to an aspect of the disclosure, wherein the latter is situated in a first valve position which corresponds to a “normal pressure operation”;

FIG. 3 shows the valve of FIG. 2 in a “high pressure operation”;

FIG. 4 shows a battery housing of the battery system of FIG. 1 in a perspective view; and

FIG. 5 shows a sectional view of the battery housing shown in FIG. 4.

### DESCRIPTION OF EXEMPLARY EMBODIMENTS

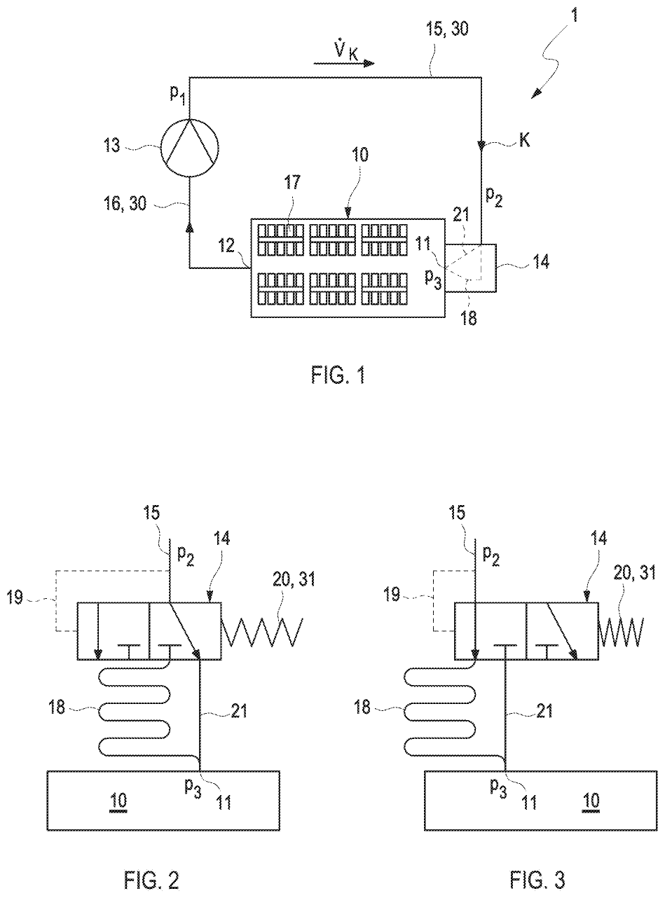

An example of a battery system 1 according to an aspect of the disclosure is schematically shown in FIG. 1. The battery system 1 has a battery housing 10. Electric accumulator cells 17 are arranged in the battery housing 10, wherein in the exemplary embodiment, the number, and the circuitry are conceived according to the requirements. The battery housing 10 can be passed through by a flow of the coolant K with which the accumulator cells 17 are cooled by dissipating heat to the coolant K. To this end, the accumulator cells 17 can be surrounded by a flow of the coolant K such that heat can be transferred from the accumulator cells 17 to the coolant K.

As shown in FIG. 1, the battery housing 10 is arranged in a closed coolant circuit 30 in which the coolant K circulates. In order for the coolant K to be directed into the battery housing 10, the latter includes a coolant inlet 11. In order for the coolant K to be directed out of the battery housing 10, the latter includes a coolant outlet 12.

The battery system 1 furthermore possesses a coolant pump 13 which by way of a pump supply line 16 is connected so as to communicate with the coolant outlet 12. Additional components of the battery system 1 such as, for example, heat exchangers herein can be arranged between the coolant pump 13 and the coolant outlet 12. For directing the coolant K through the coolant pump 13, the latter at the exit is connected by way of a pressure line 15 so as to communicate with a valve 14. Additional components such as, for example, sensors herein can also be arranged between the coolant pump 13 and the valve 14.

A first coolant duct 21 and a second coolant duct 18 are arranged so as to be in fluidic terms mutually parallel between the valve 14 and the coolant inlet 11, wherein the second coolant duct 18 possesses a higher flow resistance than the first coolant duct 21. The second coolant duct 18 thus generates a greater pressure drop in the coolant K than the first coolant duct 21.

As is visualized in FIG. 1, the first and the second coolant duct 21, 18, and the valve 14, are configured and mutually tuned in such a manner that it can be set with the valve 14 which part of the coolant flowing through the valve 14 is directed into the first coolant duct 21 and, in a manner complementary thereto, which part is directed into the second coolant duct 18.

A first position, in which the entire coolant K that enters the valve 14 is directed into the first coolant duct 21 and no coolant K is directed into the second coolant duct 18, can be set in the valve 14 herein. Moreover, a second position, in which the entire coolant K that enters the valve 14 is directed into the second coolant duct 18 and no coolant K is directed into the first coolant duct 21, can be set in the valve 14.

The coolant pump 13 in operation generates in the coolant K a fluid pressure pl which is fed into the pressure line 15. The fluid pressure of the coolant K decreases by virtue of the flow resistance in the pressure line 15 until a fluid pressure p2 which is lower than the original fluid pressure pl arises at the valve 14. As long as the fluid pressure p2 lies within a defined tolerance range, for example between 0.2 and 0.4 bar, the first position is set in the valve 14. Consequently, the valve 14 allows the coolant K to enter the battery housing 10 on the direct path, thus by way of the first coolant duct 21, on account of which the coolant K enters the battery housing 10 through the coolant inlet 11 at pressure p3.

Should the outflow of the coolant K from the battery housing 10 through the coolant outlet 12 be interrupted, the fluid pressure in the pressure line 15 at a constant output of the coolant pump 13 will increase, on account of which the fluid pressure p2 also increases. The valve 14 by virtue of this increase in pressure switches from the first position to the second position so that the coolant K is directed through a second coolant duct 18 having an increased flow resistance. The fluid pressure in the coolant K is again reduced in this way.

A fragment of the battery system 1 having the valve 14 in the first position, hereunder also referred to as the “normal pressure operating position”, is illustrated in FIG. 2. The valve 14 is typically pressure-controlled by the coolant pressure K of the coolant K, which means that the adjustment of the valve 14 between the first position and the second position is controlled with the aid of the fluid pressure of the coolant, in particular when entering the valve 14. To this end, the valve 14 possesses a control line 19 which is indicated in a rough schematic manner in FIG. 2. Resetting of the valve 14, typically to the first position, can also be carried out in a pressure-controlled manner.

Alternatively, however, the resetting of the valve 14 can also be implemented so as to be spring-loaded. To this end, the valve 14 can be embodied having a resetting installation 31 in the form of a resetting spring 20 which preloads the valve 14 towards the first position. Other suitable resetting installations 31 are however also conceivable.

As an alternative thereto, embodiments having an electric or pneumatic control unit are conceivable (not shown in the figures).

As is illustrated in FIG. 2, the fluid pressure p2 is situated within the defined tolerance range, on account of which the valve 14 adjusted to the first position connects the pressure line 15, by way of the first coolant duct 21, in fluidically direct manner to the coolant inlet 11. The second coolant duct 18 which herein is arranged parallel to the first coolant duct 21 is not passed through by a flow.

A fragment of the battery system having the valve 14 in the second position, hereunder also referred to as the “high pressure operating position”, is illustrated in FIG. 3. Identical components herein are provided with the same reference signs. As opposed to the state illustrated in FIG. 2, the pressure p2 lies above the defined tolerance range, on account of which the valve 14 blocks the flow-optimized first flow duct 21 and directs the coolant K exclusively through the second coolant duct 18 which possesses an increased flow resistance. The increased flow resistance of the second coolant duct 18 in the schematic drawing illustrated is generated by a profile which is configured so as to be meander-shaped with a larger duct length.

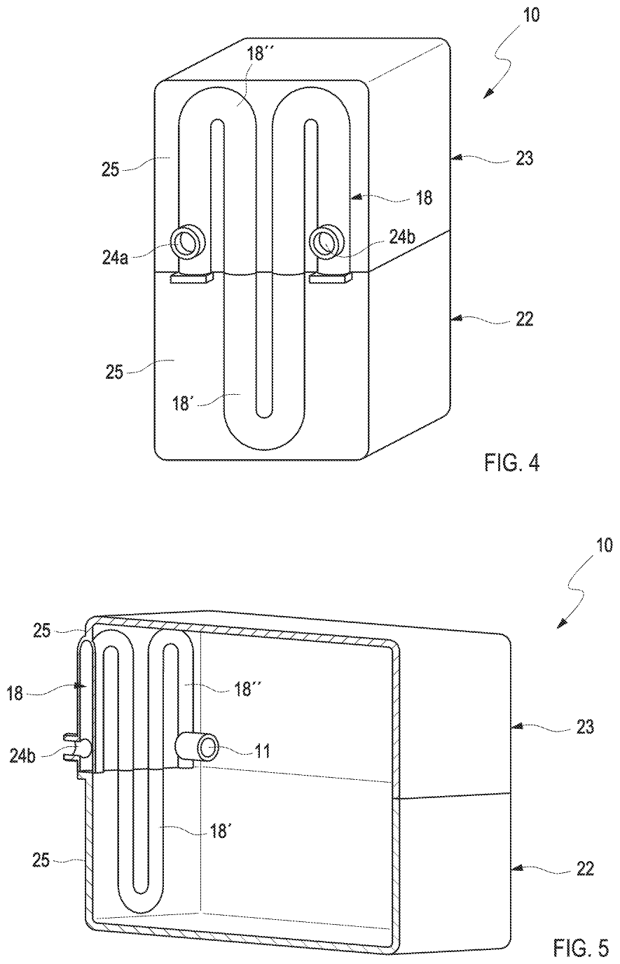

The battery housing 10 of the battery system 1 is schematically illustrated in FIGS. 4 and 5. The battery housing 10 accordingly has a first battery housing part 22 and a second battery housing part 23. The battery housing parts 22, 23 in the assembled state are connected to one another in a sealing manner. The first battery housing part 22 which in the present example is configured as a lower part, in the lateral wall 25 thereof possesses an integrated sub-region of the second coolant duct 18′. The second battery housing part 23, which in the present example is configured as an upper part, likewise possesses a sub-region of the second coolant duct 18″. Both battery housing parts 22, 23 conjointly form the second coolant duct 18. The second battery housing part 23 possesses two coolant connectors 24a and 24b which are connected to the valve 14. The coolant connector 24a represents the first coolant duct 21 which is connected to the coolant inlet 11 by way of the shortest path. The coolant connector 24b is separated from the coolant inlet 11 by the meander-shaped coolant duct 18. As can be clearly seen in FIG. 5, the lateral wall 25 of the battery housing part 23 forms the second coolant duct 18 within a cavity.

Blocking components which prevent the coolant K flowing in undesirable directions can optionally be provided within the second coolant duct 18.

As an alternative to the two coolant connectors 24a and 24b which are connected to the valve 14, only one connector pointing to the outside could also be present. A second internal coolant inlet as well as a blocking element in the coolant duct 18 are herein required in this instance in order for the short coolant duct 21 to be blocked for the coolant when required.

It is understood that the foregoing description is that of the exemplary embodiments of the disclosure and that various changes and modifications may be made thereto without departing from the spirit and scope of the disclosure as defined in the appended claims.

What is claimed is:

1. A battery system, in particular for driving a vehicle, comprising:
a battery housing;
accumulator cells; and
a coolant pump,
wherein the battery housing can be passed through by a flow of a coolant and for this purpose possesses a coolant inlet and a coolant outlet,
wherein the coolant inlet is fluidically connected to the coolant pump, and
wherein a valve which controls a volumetric coolant flow entering the battery housing is arranged between the coolant pump and the coolant inlet.

2. The battery system according to claim 1, wherein the valve is a pressure regulator valve.

3. The battery system according to claim 1, wherein the valve is a directional valve.

4. The battery system according to claim 1, wherein a first coolant duct and a second coolant duct are arranged mutually parallel in fluidic terms, between the valve and the coolant inlet, and
wherein the second coolant duct possesses a higher flow resistance than the first coolant duct.

5. The battery system according to claim 1, wherein the first and the second coolant duct and the valve are configured and mutually tuned in such a manner that it can be set with the valve what part of the flow of the coolant passing through the valve is directed into the first coolant duct and, in a manner complementary thereto, which part of the flow of coolant passing through the valve is directed into the second coolant duct.

6. The battery system according to claim 1, wherein:
the valve is adjustable to a first position in which the entire coolant that has entered the valve is directed into the first coolant duct and no coolant is directed into the second coolant duct; or/and
the valve is adjustable to a second position in which the entire coolant that has entered the valve is directed into the second coolant duct and no coolant is directed into the first coolant duct; and
the valve is adjustable to at least a third position in which the coolant that has entered the valve is in part directed into the first coolant duct and in part into the second coolant duct.

7. The battery system according to claim 6, wherein the second coolant duct for configuring a higher flow resistance in comparison to the first coolant duct possesses at least one interference geometry, in particular at least one turbulence insert and/or a cover and/or a throttle and/or a cross-sectional reduction.

8. The battery system according to claim 6, wherein the second coolant duct possesses a larger duct length than the first coolant duct.

9. The battery system according to one of claim 7, wherein the second coolant duct is configured so as to be meander-shaped and is in particular arranged on a housing wall of the battery housing.

10. The battery system according to claim 9, wherein the housing wall of the battery housing partially delimits the second coolant duct.

11. The battery system according to claim 10, wherein the second coolant duct is integrated in the housing wall and is in particular integrally moulded in the housing wall.

12. The battery system according to claim 1, wherein the battery housing is embodied in at least two parts and is in particular made of plastics material.

13. The Battery system according to claim 12, wherein the at least two parts of the battery housing together constitute the second coolant duct.

14. The battery housing for the battery system according to claim 1, comprising:
a first battery housing part; and
a second battery housing part,
wherein the first battery housing part and the second battery housing part are connected to one another in a sealing manner.
